(19) United States
(12) Patent Application Publication
(10) Pub. No.: US 2006/0180496 A1
(43) Pub. Date: Aug. 17, 2006

(54) Finger nail and toe nail decorating kit

(76) Inventors: Deborah E. Miner, Las Vegas, NV (US); Kathy Burns, Las Vegas, NV (US)

Correspondence Address: Raymond M. Galasso;Galasso & Associates LP, Suite 107, 115 Wild Basin Road, Austin, TX, 78746, US

(21) Appl. No.: 11/058,474

(22) Filed: Feb. 15, 2005

(51) Int. Cl. B44D 3/04; B65D 69/00

(52) U.S. Cl. 206/581; 206/1.8

(57) ABSTRACT

A nail decorating kit comprises a utility case including a plurality of receptacles, a plurality of paint spray cans, a plurality of nail design stencil devices, a stencil device case, an appendage support structure. The appendage support structure is configured for having a nail carrying appendage supported thereon. The stencil device case is disposed within a respective one of the receptacles. Each one of the paint spray cans is disposed within a respective one of the receptacles. At least a portion of the nail design stencil devices are disposed within the nail design stencil case. The appendage support structure is disposed within a respective one of the receptacles.

### FIELD OF THE DISCLOSURE

The disclosures made herein relate generally to decorating finger nails and toe nails and, more particularly, to kits and systems configured for decorating finger nails and toe nails.

### BACKGROUND

Individuals often decorate their finger nails and toe nails for cosmetic purposes. It is quite common for women to decorate their finger nails and toe nails with solid colors of nail polish (i.e., paint). That said, it has become increasingly common for women to decorate their finger nails and toe nails with some sort of artistic designs rather than solid colors. These artistic designs include one or more colors of paint and are conventionally applied freehand using a manually controlled application device such as a paintbrush or an airbrush (i.e., conventional application techniques).

While creation of these artistic designs is quite appealing, they are generally also quite expensive to have applied by a nail decorating professional due to the equipment and labor costs associated with their creation. Most people who have their finger nails and toe nails decorated do not have the equipment and skills required to apply such artistic designs to their own fingernails and toe nails. Also, as fingernails and toe nails that are decorated grow, it is often desirable to have the same or a different artistic designs re-applied due to exposure of the new growth portions of the nails detracting from the aesthetic beauty of an applied artistic design. Similarly, it is often desirable to have the same or a different artistic designs re-applied due to degradation from normal wear. From the perspective of the nail decorating professional, decorating nails can be an expensive profession to engage in due to the expense of required equipment (e.g., air brushes and an air compressor).

Therefore, an application approach that overcomes drawbacks associated with conventional application approaches used for creating artistic designs of finger nails and toe nails would be advantageous, useful and novel.

### SUMMARY OF THE DISCLOSURE

Embodiments of the present invention enable nail decorating professional and non-professional alike to created professional appearing artistic designs on fingernail and toe nails in a quick and relatively inexpensive manner. More specifically, embodiments of the present invention provide for a relatively inexpensive equipment investment for creating custom painted finger nails and toe nails and provide a means for enabling artistic designs to be formed. Accordingly, the present invention advantageously overcomes one or more shortcomings associated with conventional application approaches.

In one embodiment of the present invention, a packaged product configured for decorating finger nails and toe nails comprises a plurality of paint spray cans, a plurality of nail design stencil devices and an appendage support structure. The appendage support structure includes an appendage support portion configured for having a nail-carrying appendage of a person supported thereon.

In another embodiment of the present invention, a nail decorating kit comprises a utility case, a plurality of paint spray cans contained within the utility case, and a plurality of nail design stencil devices contained within the utility case.

In another embodiment of the present invention, a nail decorating kit comprises a utility case including a plurality of receptacles, a plurality of paint spray cans, a plurality of nail design stencil devices, a stencil device case and an appendage support structure. The appendage support structure is configured for having a nail carrying appendage supported thereon. The stencil device case is disposed within a respective one of the receptacles. Each one of the paint spray cans is disposed within a respective one of the receptacles. At least a portion of the nail design stencil devices are disposed within the nail design stencil case. The appendage support structure is disposed within a respective one of the receptacles.

Embodiments of nail decorating kits in accordance with the present invention are examples of packaged products configured for decorating finger nails and toe nails. In one specific embodiment of such a packaged product, the utility case is omitted and the various product articles are provided in a container such as a box or blister package. Accordingly, in at least one embodiment, a packaged product in accordance with the present invention comprises a plurality of paint spray cans, a plurality of nail design stencil devices and an appendage support structure.

Turning now to specific aspects of the present invention, in at least one embodiment, each one of the nail design stencil devices are configured for fitting over a nail carrying appendage of a person and each one of the nail design stencil devices has a respective stencil formed therein.

In at least one embodiment, a stencil device case is disposed within the stencil device case receiving receptacle.

In at least one embodiment, the stencil device case includes a plurality of stencil device receiving receptacles and each one of the nail design stencil devices is disposed in a respective one of the stencil device receiving receptacles.

In at least one embodiment, the utility case includes a plurality of stencil device receiving receptacles and each one of the nail design stencil devices is disposed in a respective one of the stencil device receiving receptacles.

In at least one embodiment, an appendage support structure is provided.

In at least one embodiment, the appendage support structure has an appendage engagement portion, a base and a pedestal extending between the appendage engagement portion and the base.

These and other objects and embodiments of the inventive disclosures made herein will become readily apparent upon further review of the following specification and associated drawings.

### BRIEF DESCRIPTION OF THE DRAWINGS

FIG. 1 depicts a first embodiment of a nail decorating kit in accordance with the present invention.

FIG. 2 depicts an embodiment of a paint spray can in accordance with the present invention.

FIG. 3 depicts an embodiment of a stencil device case and nail design stencil devices in accordance with the present invention.

FIG. 4 depicts an embodiment of an appendage support structure in accordance with the present invention.

FIG. 5 depicts a second embodiment of a nail decorating kit in accordance with the present invention.

### DETAILED DESCRIPTION OF THE DRAWINGS

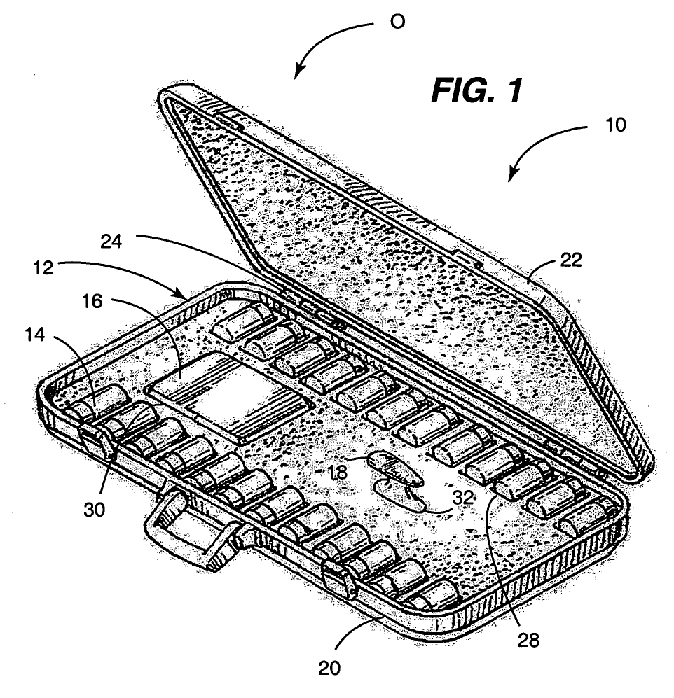

FIG. 1 depicts a first embodiment of a nail decorating kit in accordance with the present invention, which is denoted generally as nail decorating kit 10. The nail decorating kit 10 comprises a utility case 12, a plurality of paint spray cans 14 contained within the utility case 12, a stencil device case 16 contained within the utility case 12 and an appendage support structure 18 contained within the utility case 12. The paint spray cans 14, the stencil device case 16 and the appendage support structure 18 are removably contained within the utility case 12.

The utility case 12 includes a base section 20 and a cover section 22. The cover section 22 is movably mounted on the base section 20 via a plurality of hinges 24. The cover section 22 is movable between a closed position (not specifically shown) and an open position 0 (shown). The utility case 12 includes a plurality of receptacles. Each one of the paint spray cans 14 is removably disposed within a respective spray can receptacle 28. The stencil device case 16 is removably disposed within a stencil device case receptacle 30. The appendage support structure 18 is removably disposed within a support structure receptacle 32.

In one embodiment of the utility case 12, the various receptacles of the utility case 12 are integrally formed in surfaces of the walls of the utility case 12. In another embodiment of the utility case 12, the utility case 12 includes an insert member (e.g., a foam insert) and the various receptacles of the utility case 12 are integrally formed in the insert member (e.g., cut outs in the foam insert).

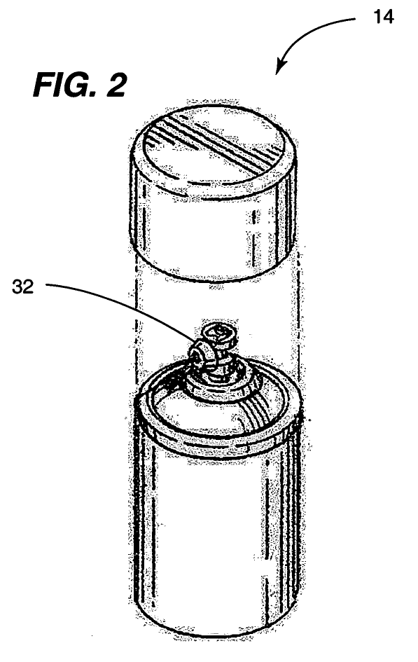

At least a portion of the paint spray cans 14 each contain different color paints. Preferably, but not necessarily, each paint spray can 14 contains aerosolised acrylic paint and the spray head 32 (FIG. 2) is configured for delivering a relatively light, fine mist of paint resembling the spray pattern/spray effect from an airbrush. In other embodiments, each paint spray can 14 contains aerosolised paint composition typically available in aerosolised format (e.g., commercially available lacquer spray paint, epoxy spray paint, enamel spray paint, etc) and the spray head 32 (FIG. 2) is configured for delivering a spray pattern/spray effect similar to that of a conventional can of spray paint. It is further disclosed herein that a variety of replaceable spray heads may be provided that each provide a different type of spray characteristic (i.e., a fine mist, a sharp line, a round spot, etc). Alternately, a single spray head that is adjustable for providing such variety of spray characteristics may be provided.

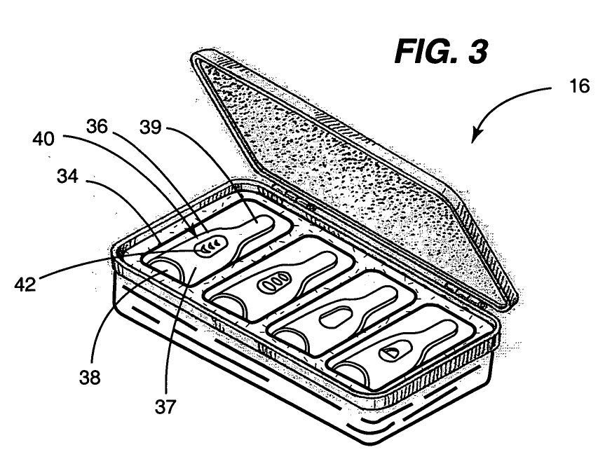

Referring now to FIG. 3, the stencil device case 16 includes a plurality of stencil device receptacles 34 and contains a plurality of nail design stencil devices 36. Each one of the nail design stencil devices 36 is removably disposed in a respective one of the stencil device receptacles 34. Each one of the nail design stencil devices 24 has a body 37 having an opening 38 and a hand-gripping portion 39. Accordingly, each nail design stencil device 36 may be fitted over a nail-carrying appendage (e.g., finger or toe) of a person and held in place via the hand-gripping portion 39. Each nail design stencil device 36 includes a stencil 40 that consists of a one or more opening 42 through which paint can be applied to an underlying nail. Preferably, but not necessarily, each one of the nail design stencil devices 36 is constructed of a relatively thin, flexible, non-porous polymeric material and that is relatively resistant to solvents used in aerosolised spray paint and used to remove residual aerosolised spray paint.

It is disclosed herein that the nail design stencil devices may include stencils according to a particular themes, holidays and/or events. Examples of such themes, holidays and/or events include, but are not limited to, religious holidays, birthday, Valentine's day, a national holiday, etc. Additionally, various kits may include different quantities and types of paint spray cans (e.g., different types of paints, spray heads, etc) and different quantities and types of nail design stencil devices.

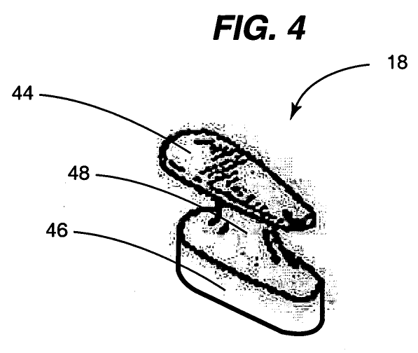

Referring to FIG. 4, the appendage support structure 18 is configured for enabling a person to position and hold a nail carrying appendage in a relatively stable position. To achieve professional quality results, it is advantageous to limit movement of a nail being painted. The appendage support structure 18 has an appendage engagement portion 44, a base 46 and a pedestal 48. The appendage engagement portion 44 is configured for having an appendage carrying a nail supported thereon. The pedestal 48 extends between the appendage engagement portion 44 and the base 46. Preferably, but not necessarily, the appendage support structure 18 is constructed of a non-porous polymeric material and that is relatively resistant to solvents used in aerosolised spray paint and used to remove residual aerosolised spray paint.

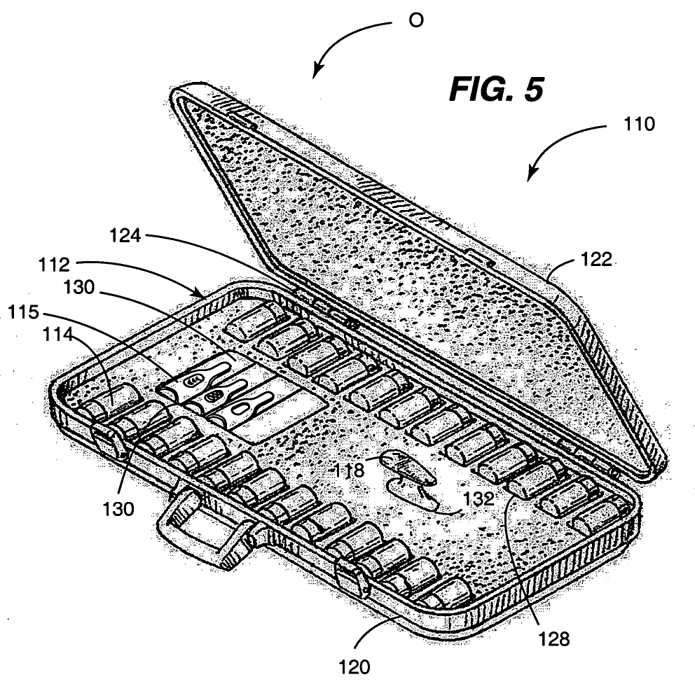

FIG. 5 depicts an embodiment of a second nail decorating kit in accordance with the present invention, which is denoted generally as nail decorating kit 100. The nail decorating kit 100 comprises a utility case 112, a plurality of paint spray cans 114 contained within the utility casel 12, a plurality of nail design stencil devices 115 contained within the utility case 112 and an appendage support structure 118 contained within the utility case 112. The paint spray cans 114, the nail design stencil devices 115 and the appendage support structure 118 are removably contained within the utility case 112. The paint spray cans 114, the nail design stencil devices 115 and the appendage support structure 118 are substantially the same construction as their respective counterparts depicted in FIGS. 1-4.

The utility case 112 includes a base section 120 and a cover section 122. The cover section 122 is movably mounted on the base section 120 via a plurality of hinges 124. The cover section 122 is movable between a closed position (not specifically shown) and an open position 0 (shown). The utility case 112 includes a plurality of receptacles. Each one of the paint spray cans 114 is removably disposed within a respective spray can receptacle 128. Each one of the nail-design stencil devices 115, which are each substantially the same construction as the nail design stencil devices 36 depicted in FIG. 3, is removably disposed within a respective stencil device receptacle 130. The appendage support structure 118 is removable disposed within a support structure receptacle 132.

In one embodiment of the utility case 112, the various receptacles of the utility case 112 are integrally formed in surfaces of the walls of the utility case 112. In another embodiment of the utility case 112, the utility case 112 includes an insert member (e.g., a foam insert) and the various receptacles of the utility case 112 are integrally formed in the insert member (e.g., cut outs in the foam insert).

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice embodiments of the inventive disclosure made herein. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A packaged product configured for decorating finger nails and toe nails, comprising:
a plurality of paint spray cans;
a plurality of nail design stencil devices; and
an appendage support structure including an appendage support portion configured for having a nail-carrying appendage of a person supported thereon.

2. The packaged product of claim 1 wherein:
the appendage support structure further includes a base and a pedestal; and
the pedestal extends between the appendage engagement portion and the base.

3. The packaged product of claim 1 wherein:
each one of the nail design stencil devices are configured for fitting over a nail carrying appendage of a person; and
each one of the nail design stencil devices has a respective stencil formed therein.

4. The packaged product of claim 3 wherein:
the appendage support structure further includes a base and a pedestal; and
the pedestal extends between the appendage engagement portion and the base.

5. A nail decorating kit, comprising:
a utility case;
a plurality of paint spray cans contained within the utility case; and
a plurality of nail design stencil devices contained within the utility case.

6. The nail decorating kit of claim 5 wherein:
the utility case includes a plurality of spray can receiving receptacles; and
each one of said paint spray cans is disposed within a respective one of said spray can receiving receptacles.

7. The nail decorating kit of claim 5 wherein:
each one of the nail design stencil devices are configured for fitting over a nail carrying appendage of a person; and
each one of the nail design stencil devices has a respective stencil formed therein.

8. The nail decorating kit of claim 5, further comprising:
a stencil device case is disposed within a receptacle configured for receiving the nail design stencil case of the utility case.

9. The nail decorating kit of claim 8 wherein:
the stencil device case includes a plurality of stencil device receiving receptacles; and
each one of said nail design stencil devices is disposed in a respective one of said stencil device receiving receptacles.

10. The nail decorating kit of claim 5 wherein:
the utility case includes a plurality of stencil device receiving receptacles; and
each one of said nail design stencil devices is disposed in a respective one of said stencil device receiving receptacles.

11. The nail decorating kit of claim 5, further comprising:
an appendage support structure.

12. The nail decorating kit of claim 11 wherein:
the appendage support structure has an appendage engagement portion, a base and a pedestal extending between the appendage engagement portion and the base.

13. The nail decorating kit of claim 5, further comprising:
an appendage support structure,
wherein the nail-carrying appendage support structure has an appendage engagement portion, a base and a pedestal extending between the appendage engagement portion and the base;
wherein the utility case includes a plurality of spray can receiving receptacles;
wherein each one of said paint spray cans is disposed within a respective one of said spray can receiving receptacles;
wherein each one of the nail design stencil devices are configured for fitting over a nail carrying appendage of a person; and
wherein each one of the nail design stencil devices has a respective stencil formed therein.

14. The nail decorating kit of claim 13, further comprising:
a stencil device case disposed within a stencil device case receiving receptacle.

15. The nail decorating kit of claim 14 wherein:
the stencil device case includes a plurality of stencil device receiving receptacles.

16. The nail decorating kit of claim 13 wherein:
the utility case includes a plurality of stencil device receiving receptacles; and
each one of said nail design stencil devices is disposed in a respective one of said stencil device receiving receptacles.

17. A nail decorating kit, comprising:
a utility case including a plurality of receptacles;
a plurality of paint spray cans, wherein each one of said paint spray cans is disposed within a respective one of said receptacles;
a plurality of nail design stencil devices;
a stencil device case disposed within a respective one of said receptacles, wherein at least a portion of said nail design stencil devices are disposed within the nail design stencil case; and
an appendage support structure configured for having a nail carrying appendage supported thereon, wherein the appendage support structure is disposed within a respective one of said receptacles.

18. The nail decorating kit of claim 17 wherein:
each one of the nail design stencil devices are configured for fitting over a nail carrying appendage of a person; and
each one of the nail design stencil devices has a respective stencil formed therein.

19. The nail decorating kit of claim 18 wherein:
the appendage support structure has an appendage engagement portion, a base and a pedestal extending between the appendage engagement portion and the base.
